(19) United States
(12) Patent Application Publication
(10) Pub. No.: US 2005/0047982 A1
(43) Pub. Date: Mar. 3, 2005

(54) Engine emissions nox reduction

(76) Inventors: Lester P. Berriman, Irvine, CA (US); Lionel S. Simons, Dana Point, CA (US); John M. Zabsky, Santa Ana, CA (US)

Correspondence Address: LEON D. ROSEN;FREILICH, HORNBAKER & ROSEN, Suite 1220, 10960 Wilshire Blvd., Los Angeles, CA, 90024, US

(21) Appl. No.: 10/918,111

(22) Filed: Aug. 13, 2004

Related U.S. Application Data
(60) Provisional application No. 60/498,754, filed on Aug. 29, 2003.

(51) Int. Cl. B01D 53/56

(52) U.S. Cl. 423/235; 422/172; 422/177; 422/180

(57) ABSTRACT

An engine assembly of the type that includes a conduit (16) extending from the exhaust manifold outlet (14) to the atmosphere (20), an ammonia injection station (22) along the conduit, and a catalytic assembly (24) lying along the conduit and downstream of the ammonia injection station. The catalytic assembly includes a surface wash coat (50) of a nitric-oxide catalyzing material that converts nitric oxide (NO) to nitrogen dioxide (NO₂), and passages coated with SCR (selective catalyst reduction) catalyst that reacts ammonia with NO₂ to produce nitrogen and water. The catalytic assembly includes multiple elements such as fibers, coated with the SCR catalyzing material, with the elements lying in a mass and with passages, or pores lying between the elements. The mass lies in a tube (90) of the conduit, and has conical inside and outside surfaces (42, 40) to provide a large area through which gasses flow. A catalyst arrangement 80 such as the honeycomb type with an oxidizing catalyst on the passage walls, can also lie in the casing (90) of the catalytic assembly, but preferably downstream of the nitric oxide and SCR catalysts.

### CROSS REFERENCE

Applicant claims priority from U.S. provisional application Ser. No. 60/498,754 filed Aug. 29, 2003.

### BACKGROUND OF THE INVENTION

Our earlier U.S. Pat. No. 5,992,141, describes the injection of ammonia (NH₃) and its components (NH₂ and/or NH+H) into hot exhaust gasses, especially those of a diesel engine, to reduce smog that arises from nitrogen oxides in the atmosphere. The injected ammonia reacts catalytically and non-catalytically with nitrogen oxides, including nitric oxide (NO) and nitrogen dioxide (NO₂) to produce nitrogen and water vapor.

Applicant's experiments show that ammonia (and its components) react much faster and more completely with nitrogen dioxide (NO₂) than with nitric oxide (NO). It would be desirable if a high proportion of nitric oxides in the exhaust gasses could be converted into nitrogen dioxides, preferably where the gasses are still hot, along the exhaust gas conduit that extends from the engine exhaust manifold to the atmosphere.

### SUMMARY OF THE INVENTION

In accordance with one embodiment of the invention, applicant provides a nitric-oxide catalyst along the exhaust gas conduit, which converts a high proportion of nitric oxide (NO) in the exhaust gasses into nitrogen dioxide (NO₂). The catalyst lies in a casing of the exhaust gas conduit. An SCR (selective catalyst reduction) catalyst that efficiently reacts ammonia and nitrogen dioxide, lies in the same casing, and downstream of the nitric oxide catalyst. The downstream end of the casing preferably includes an oxidizing catalyst, that oxidize carbon monoxide and unburned hydrocarbons.

The nitric-oxide catalyst includes a mass of small elements with a surface wash coat on its upstream surface that converts NO to NO₂. The SCR catalyst coats the multiple elements of the mass to leave multiple small pores between the elements where the exhaust gasses are exposed to a large area of the catalyst. A preferred arrangement is to establish the mass of elements so it has conical inside and outside surfaces. The conical angles are preferably no more than 45°, such as 30°, to provide a large area in a limited space.

The novel features of the invention are set forth with particularity in the appended claims. The invention will be best understood from the following description when read in conjunction with the accompanying drawings.

### BRIEF DESCRIPTION OF THE DRAWINGS

FIG. 1 is a side elevation view of an engine arrangement of the present invention.

FIG. 2 is a sectional view of the catalyst assembly of the arrangement of FIG. 1.

FIG. 3 is an enlarged sectional view of a portion of the catalyst assembly of FIG. 2

FIG. 4 is a sectional view of the catalyst mass of FIG. 2, in which an additional catalyst apparatus has been added.

FIG. 5 is a sectional view of a portion of the additional catalyst apparatus of FIG. 4

FIG. 6 is a sectional view of the catalyst mass of FIG. 4, in which a different catalyst apparatus has been added.

FIG. 7 is an enlarged view of a portion of the catalyst assembly of FIG. 3.

FIG. 8 is a sectional view taken on line 8-8 of a portion of the catalyst assembly of FIG. 2.

### DESCRIPTION OF THE PREFERRED EMBODIMENTS

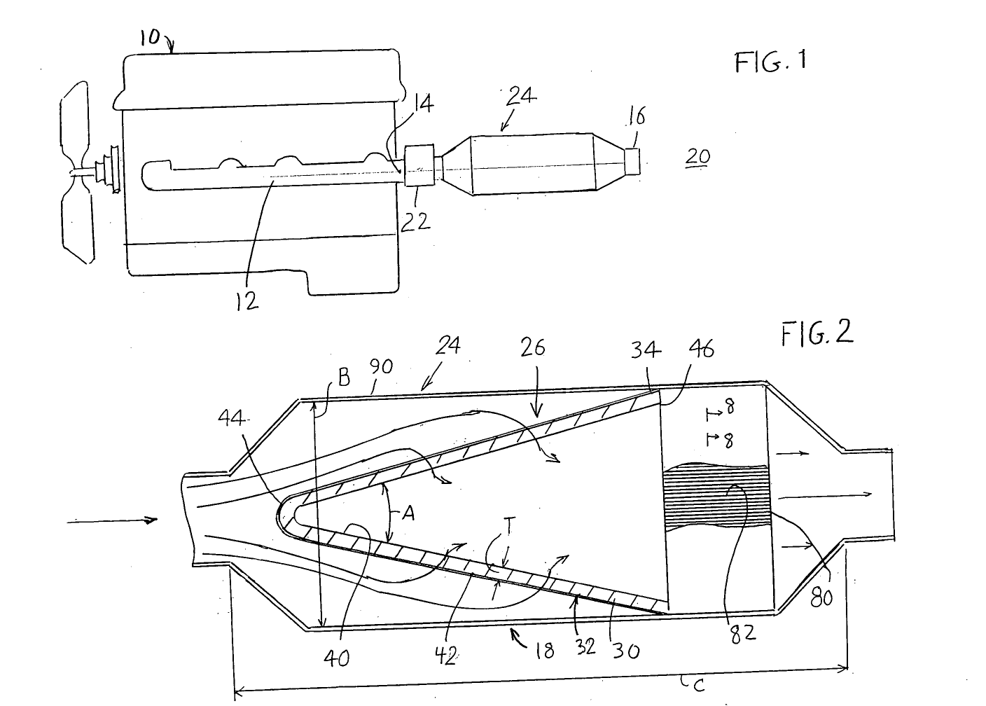

FIG. 1 illustrates a diesel engine assembly 10 with an exhaust manifold 12 into which hot exhaust gasses are released by cylinders of the engine. At the manifold outlet 14, the nitrogen oxides in the exhaust gasses consist of about 90% nitric oxide (NO) and about 10% nitrogen dioxide (NO₂). The exhaust gasses are carried by an exhaust gas conduit 16 from the manifold outlet to the atmosphere 20. An ammonia injection station 22 which lies along the conduit is of the type described in our earlier U.S. Pat. No. 5,992,141, where ammonia (NH₃) and its components (the combination herein referred to simply as ammonia) are injected into the hot exhaust gasses. Immediately downstream of the ammonia injection station, applicant provides a catalyzing assembly 24 in which considerable nitric oxide (NO) is converted into nitrogen dioxide (NO₂) and the resulting nitrogen oxides (NO and NO₂) are reacted with already-injected ammonia to produce nitrogen and water vapor and a minimum of remaining nitrogen oxides. Applicant finds that a much higher percent of nitrogen dioxide than nitric oxide reacts with ammonia to produce the harmless components consisting of nitrogen (which constitutes most of the air) and water.

FIG. 2 shows that the catalyzing assembly 24 includes a cone-shaped coated structure 26 that includes a layer 30 of material in the shape of a cone 32, with conical inner and outer surfaces 40,42, and upstream and downstream ends 44, 46. The particular fibrous cone 32 (which may be truncated), which has a thickness T on the order of magnitude of 0.4 inch, and preferably less than one inch, has an expansion angle A of about 30°. An expansion angle of no more than about 45° is preferred, to provide large inside and outside surface areas within a limited tube diameter B such as 6 inches. The length C of about 18 inches is also limited by available space and by the fact that there is a rapid decline of exhaust gas temperature with increasing length. Catalyzing of gas components increases with gas temperature.

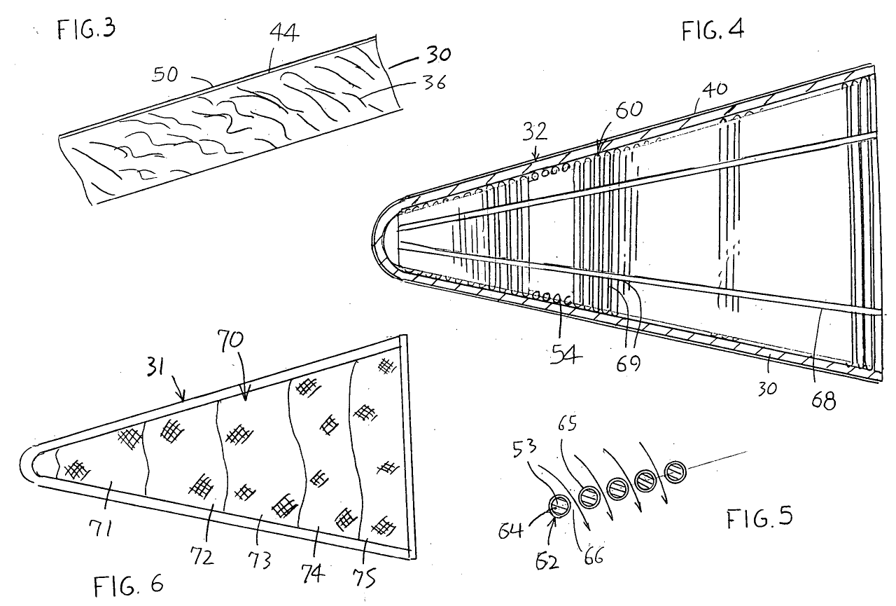

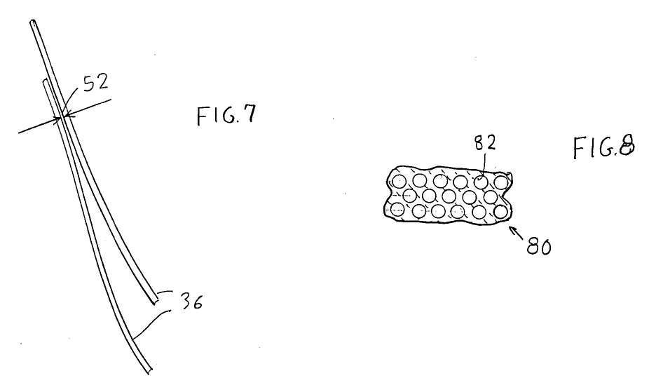

FIG. 3 is a sectional view of a portion of the layer 30 that forms a cone, showing that it includes coated fibers 36 and an outer wash coating 50 on the outside of the cone. The layer 30 is formed from ceramic fibers such as those of silica. The individual fibers are coated with an SCR (selective catalyst reduction) coating which accelerates the reaction of ammonia and nitrogen dioxide (NO₂). The fibers are either coated and then compressed or compressed and then soaked in the catalyst material. A small amount of a high temperature bonding agent may be applied to better hold the fibers together. The compression is sufficient to hold the fibers together, but still leaves minute passages or pores 52 (FIG. 7) between the fibers. Gasses flowing through the pores between the coated fibers are exposed to the SCR catalyzing material and are catalyzed to react ammonia with NO₂. The fibers are much less than 1 mm in diameter, and the pores or passages 52 between a multiplicity of adjacent fibers is much less than 1 mm.

The wash coating 50 on the outside of the cone comprises a nitric oxide catalyst which converts nitric oxide (NO) to nitrogen dioxide (NO₂) using oxygen in the exhaust gasses. As mentioned above ammonia reacts more completely with nitrogen dioxide (NO₂) than with nitric oxide (NO). One suitable nitric oxide catalyst is a proprietary one offered by KleenAir Systems, Inc. of Irvine, Calif. which includes platinum.

The SCR catalyzing material which coats the fibers, serves to react ammonia (NH₃ and its reactive components NH₂, NH, and H) with nitrogen oxides and especially nitrogen dioxide (NO₂), to produce nitrogen and water. One effective SCR material is a proprietary SCR coating offered by Catalytic Systems, Inc. of Oxnard, Calif., which efficiently reacts ammonia and nitrogen dioxide. The nitric oxide catalyst is far more effective in converting NO to NO₂ than the SCR catalyst, and the SCR catalyst is more effective in reacting ammonia and nitric oxide than is the nitric oxide catalyst.

The placement of the nitric oxide catalyst of the outer wash coat 50, close to the SCR catalyst of the coated fibers 36 increases the effectiveness of the combination in reducing the amount of nitrogen oxides released into the environment. Although the nitric oxide catalyst converts much of the NO to NO₂, some of the NO₂ may convert back to NO; the closeness (within 3 inches and preferably within one inch) of the SCR catalyst in the presence of ammonia helps complete conversion to nitrogen and water while there is a high concentration of nitrogen dioxide. In addition, the closeness of the two catalysts minimizes temperature drop of the exhaust gasses, especially compared to catalysts in separate units with separate casing.

FIG. 7 shows that the fibers of the cone are spaced apart to leave thin pores or passages 52 through which gas passes. The fibers are multiple elements, each coated with an SCR catalyzing material which speeds the reaction of ammonia and nitrogen dioxide.

The elongated cone shape of the cone 32 shown in FIG. 2, provides a one-piece element that is simple to produce, and that provides a large surface area and a correspondingly large area of contact of exhaust gasses with the outer coating 50 and with the coating on the fibers of the layer of the cone.

In order to obtain an optimum proportion of nitric oxide catalyst and SCR catalyst, applicant can place fibers coated with nitric oxide catalyst at the outer (upstream) portion of the cone and a layer of SCR-coated fibers at the inner (downstream) portion of the cone. It is also possible to provide an additional smaller, hollow cone in the space 40 within the outer cone 32. In that case, some or all of the fibers of the outer cone are coated with nitric oxide catalyst while the fibers of the inner cone are coated with SCR catalyst. Instead of a smaller fibrous cone within outer cone 32, other devices can lie in the outer cone.

FIG. 2 shows an additional catalyst arrangement 80 at the downstream end of the coated structure 30. The additional catalyst arrangement 80 includes a honeycomb arrangement with multiple passages 82 coated with oxidizing catalytic material which converts carbon and carbon monoxide into carbon dioxide. Such oxidizing catalyst material is widely available but is proprietary to each supplier. As shown in FIG. 8, the catalyst arrangement includes only a single block of more than one inch thickness with passages in the block, rather than multiple small elements. The fact that the nitric oxide catalyst lies in the same tube with confining upstream and downstream ends, or casing 90 of the conduit as the catalyst arrangement 80, shortens the distance between them so the exhaust gasses are hotter along the catalyst arrangement 80. The shortest distance between the nitric oxide catalyst and the SCR catalyst is preferably less than one inch. The shortest distance between the SCR catalyst and the oxidizing catalyst is preferably less than three inches and more preferably less than an inch.

FIG. 4 shows a wound wire cone 60 that lies within the fibrous cone 32 of coated fibers. The wound wire cone 60 includes numerous windings in a tapered helix shape, of a wire 62 (FIG. 5) that includes a wire core 64 coated with an SCR catalyst 65 or a nitric oxide catalyst. There is a small gap 66 between adjacent turns of the wire through which exhaust gasses can readily flow, but pass in contact with the catalyst coating 65 of the wires. In one example, the wires have steel cores of 0.5 mm diameter that are coated with a catalyzing wash 65 of 0.02 mm thickness, and are spaced apart with a gap 66 of 0.1 mm between turns of the wire. A plurality of cross bars 68 are used to maintain the positions of the wire turns 69. The turns of wire each constitutes an elongated element coated with a catalyst.

FIG. 6 shows another device 70 in the form of masses, or pieces 71-75, of fine stainless steel wool, with the wire of the stainless steel wool coated with an SCR catalyst or a nitric oxide catalyst. This can be accomplished by dipping the original stainless steel wool into a bath of liquid material that includes a catalyst, and allowing the liquid to dry in a manner that preserves the fine pores between the wires and elasticity of the stainless steel wool. The stainless steel wool masses are packed into the cone so exhaust gasses must flow through the steel wool in order to exit it.

Test show that exhaust gas at the manifold outlet 14 contained 90% NO and 10% NO₂. After passing slowly through the above nitric oxide catalyst, the exhaust gasses contained 30% NO and 70% NO₂, so the nitric oxide catalyst converted more than 10% and actually more than 20% of the NO to NO₂. The other catalysts (SCR and oxidizing catalysts) are far less effective in converting NO to NO₂.

Thus, the invention provides a low cost emission reduction system, which includes a nitric oxide catalyst that converts nitric oxide (NO) to nitrogen dioxide (NO₂), followed by an SCR (selective catalyst reduction) catalyst that reacts ammonia with nitrogen oxides and especially nitrogen dioxide (NO₂). Either catalyst is a coating on multiple elongated elements, each having a length at least ten times its diameter and coated with the oxidizing coating, and with the elements held together in a mass with narrow pores or passages between adjacent one of the elements. The elements each have a diameter no more than one millimeter and the distance between them is less than one millimeter. The elements preferably lie in a cone-shaped mass with conical inner and outer surfaces, each with a cone angle of no more than about 45° (less than 52.5°). The elements can include ceramic fibers containing an SCR catalyst coating, with a coating of nitric oxide catalyst lying on the outside surface of the cone. In addition, coated wire turns or other catalyst-coated parts can lie in the cone.

Although particular embodiments of the invention have been described and illustrated herein, it is recognized that modifications and variations may readily occur to those skilled in the art, and consequently, it is intended that the claims be interpreted to cover such modifications and equivalents.

1. An engine assembly that has an exhaust gas manifold and an exhaust conduit extending from the exhaust gas manifold to the atmosphere to carry exhaust gasses downstream from said manifold to the atmosphere, the engine assembly including an ammonia injection station along the conduit where ammonia and its components are injected into the conduit to reduce nitrogen oxides in the exhaust gasses, and a catalytic assembly lying along the conduit downstream of the ammonia injection station where the exhaust gasses are catalyzed, the improvement wherein:
said catalytic assembly includes a casing of said conduit, and at least one mass that lies in said casing and which has multiple passages with passage walls coated with catalytic material;
a quantity of nitric oxide catalyst that converts nitric oxide (NO) to nitrogen dioxide (NO₂) and that coats at least an upstream portion of said mass that said gasses pass across;
a quantity of SCR (selective catalyst reduction) catalyst that reacts ammonia with nitrogen dioxide to produce nitrogen and water, and that coats at least second portions of said passage walls;
said second portions of said passage walls lie downstream of said coating of nitric oxide catalyst.

2. The engine assembly described in claim 1 wherein:
said mass comprises multiple elements, each element having a diameter no more than one millimeter and a length at least ten times its diameter;
said quantities of nitric oxide and SCR catalyst each coats a multiplicity of said multiple elements;
said multiple elements of said mass being held close together, but with a narrow gap of less than one millimeter between multiple adjacent ones of said elements, said casing confining said exhaust gasses so said exhaust gasses must pass through said narrow gaps to pass through the catalytic assembly.

3. The engine assembly described in claim 2 wherein:
said multiple elements are multiple fibers and at least one of said catalysts coats said fibers, said multiple fibers being held pressed together in a mass of fibers.

4. The engine assembly described in claim 2 wherein:
said multiple elements are turns of a wire core, at least one of said catalysts lying on the outer surface of the wire core, and the turns of the coated wire core being spaced apart to leave each of said gaps.

5. The engine assembly described in claim 2 wherein:
said mass of multiple elements are held in a conical shape of a hollow cone with a cone angle of no more than about 45°, and with the tube of the conduit constructed to allow exhaust gasses to pass through the tube only by passing through walls of the hollow cone.

6. The engine described in claim 1 including:
a honeycomb mass with a multiplicity of uniformly spaced passages that are each coated with an oxidizing catalytic material, said honeycomb mass also lying in said casing of said conduit, whereby to minimize decrease in exhaust gas temperature as the gas passes across catalytic material.

7. The engine described in claim 6 wherein:
the closest distance between said SCR catalyst and said oxidizing catalyst is no more than one inch.

8. The engine described in claim 1 wherein:
the closest distance between said nitric oxide catalyst and said SCR catalyst is no more than one inch.

9. An engine assembly that has an exhaust gas manifold and an exhaust conduit extending from the exhaust gas manifold to the atmosphere to carry exhaust gasses downstream therealong, the engine assembly including an ammonia injection station along the conduit where ammonia and its components are injected into the conduit to reduce nitrogen oxides in the exhaust gasses, and a catalytic assembly downstream of the ammonia injection station where the exhaust gasses are catalyzed, the improvement wherein:
said catalytic assembly includes a casing forming part of said conduit, and multiple elements each coated with a catalytic material and lying in a mass with pores between said element, said mass forming cone walls having conical inside and outside surfaces, said mass lying in said tube and blocking the flow of exhaust gasses therethrough unless said gasses flow through said cone walls;
said conical outside surface having a coating of a nitric oxide catalyst which converts nitric oxide (NO) to nitrogen dioxide (NO₂), and a multiplicity of said elements being coated with SCR (selective catalyst reduction) catalyst which reacts ammonia with nitrogen dioxide.

10. The engine assembly described in claim 9 wherein:
said multiple elements comprising coated fibers held in a matt wherein the fibers are pressed close together.

11. The engine assembly described in claim 10 including:
a wire cone comprising multiple turns of a catalyst coated wire that are wound about an axis of one of said conical surfaces and that lie inside said cone walls.

12. The engine assembly described in claim 9 including:
a quantity of compressible flexible material having multiple pores with pore surfaces of catalytic material, said quantity of compressible flexible material being stuffed into said inner conical surface of said mass.

13. The engine described in claim 7 wherein:
the average thickness of said cone walls, between said inside and outside surfaces, is no more than one inch.

14. A method for treating diesel engine exhaust gasses that include nitric oxide (NO) and nitrogen dioxide (NO₂) to reduce nitrogen oxides released into the atmosphere, which includes injecting ammonia into the exhaust gasses, comprising:
flowing the exhaust gasses across a nitric oxide catalyst that converts more than 10% of the nitric oxide (NO) to nitrogen dioxide, and then flowing the exhaust gasses across a second catalyst that reacts ammonia with nitrogen dioxide.

15. The method described in claim 14 wherein:
said steps of flowing include flowing at least some of the gasses that have passed across the nitric oxide catalyst, across said second catalyst within three inches of the gasses having been in contact with the nitric oxide catalyst.
